(19) United States
(12) Patent Application Publication
(10) Pub. No.: US 2021/0184199 A1
(43) Pub. Date: Jun. 17, 2021

(54) METHODS OF LITHIATING METAL ANODES USING ELECTROLYTES

(71) Applicant: GM GLOBAL TECHNOLOGY OPERATIONS LLC, Detroit, MI (US)

(72) Inventors: Meinan HE, Madison Heights, MI (US); Shuru CHEN, Troy, MI (US); Biqiong WANG, Madison Heights, MI (US); Mei CAI, Bloomfield Hills, MI (US)

(21) Appl. No.: 16/711,195

(22) Filed: Dec. 11, 2019

(51) Int. Cl. H01M 4/04; H01M 4/1395; H01M 4/38; H01M 10/0525

(52) U.S. Cl. CPC H01M 4/0416; H01M 4/1395; H01M 2004/027; H01M 4/386; H01M 10/0525; H01M 4/0435

(57) ABSTRACT

A method for preparing an electrochemical cell that cycles lithium ions is provided. The method includes lithiating an electroactive material using a first electrolyte and contacting the lithiated electroactive material and a second electrolyte to form the electrochemical cell. Lithiating the electroactive material includes contacting the electroactive material and a first electrolyte to form a pretreated electroactive material; contacting a lithium source and the pretreated electroactive material; and applying a pressure to the lithium source and the pretreated electroactive material so as to form a lithiated electroactive material. The first electrolyte includes greater than or equal to about 10 wt. % to less than or equal to about 50 wt. % of one or more solvents selected, including for example, fluoroethylene carbonate (FEC). The second electrolyte includes less than or equal to about 5 wt. % of cyclic carbonates and, in certain aspects, one or more electrolyte additives.

### INTRODUCTION

This section provides background information related to the present disclosure which is not necessarily prior art.

The present disclosure relates to electroactive materials and electrolytes for use in electrodes of lithium-ion electrochemical cells and methods of making the same, for example methods for lithiating electroactive materials, such as metal anodes, using electrolyte formulations and additives for electrolytes used in electrochemical cells including the lithiated metal anode.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”). Typical lithium-ion batteries include at least two electrodes and an electrolyte and/or separator. One of the two electrodes serves as a positive electrode or cathode and the other electrode serves as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions and electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

In various instances, however, in particular in the instance of electroactive materials including, for example, silicon, which has the highest known theoretical charge capacity, making it one of the most promising materials for rechargeable lithium-ion batteries, but which experiences excessive volumetric expansion and contraction (e.g., 300%) during successive charging and discharging, a portion of the intercalated lithium remains with the negative electrode following the first cycle due to, for example, the formation of LiₓSi_{y}O_{z} and/or a solid electrolyte interphase (SEI) layer on the negative electrode during the first cycle, as well as ongoing lithium loss due to continuous solid electrolyte interphase breakage. Such permanent loss of lithium ions may result in a decreased specific energy and power in the battery resulting from added positive electrode mass that does not participate in the reversible operation of the battery. For example, the lithium-ion battery may experience an irreversible capacity loss of greater than or equal to about 5% to less than or equal to about 30% after the first cycle.

Lithiation, for example pre-lithiation, may compensate for such capacity losses. Common lithiation methods, such as electrochemical and lamination methods, however, require half-cell fabrication and tear-down and/or low yield processes, these are time consuming and often cost prohibitive. These processes also commonly produce unworkable materials, for example anodes having undesirable thicknesses. Accordingly, it would be desirable to develop improved electroactive and electrode materials, and methods of making the same, for an electrochemical cell that can address these challenges.

### SUMMARY

This section provides a general summary of the disclosure, and is not a comprehensive disclosure of its full scope or all of its features.

In various aspects, the present disclosure provides a method for lithiating an electroactive material. The method includes contacting an electroactive material and an electrolyte to form a pretreated electroactive material; contacting a lithium source and the pretreated electroactive material; and applying pressure to the lithium source and the pretreated electroactive material so as to form a lithiated electroactive material.

In one aspect, contacting of the lithium source and the pretreated electroactive material and the applying of pressure to the lithium source and the pretreated electroactive material may occur concurrently.

In one aspect, the method may be a continuous process conducted at least partially on a roller system including a plurality of rollers. Two or more rollers of the plurality of rollers may be configured to conduct the applying pressure to the lithium source and the pretreated electroactive material.

In one aspect, the plurality of rollers may further include at least one additional roller that is at least partially disposed within the electrolyte. The at least one additional roller may be configured to conduct the contacting of the electroactive material and the electrolyte to form the pretreated electroactive material prior to encountering the two or more rollers.

In one aspect, the contacting of the electroactive material and the electrolyte further includes spraying the electrolyte onto one or more surfaces of the electroactive material to form the pretreated electroactive material.

In one aspect, the two or more rollers of the plurality of rollers may be either coated with the lithium source or formed from the lithium source.

In one aspect, the applied pressure may be greater than or equal to about 10 PSI to less than or equal to about 100 PSI.

In one aspect, the electrolyte may include greater than or equal to about 0.1 M to less than or equal to about 4.0 M of one or more lithium salts and greater than or equal to about 10 wt. % to less than or equal to about 50 wt. % of one or more solvents. The one or more lithium salts may be selected from the group consisting of: lithium hexafluorophosphate (LiPF₆), lithium fluorosulfonylimide (LiN(FSO₂)₂) (LiFSI), lithium perchlorate (LiClO₄), lithium tetrafluoroborate (LiBF₄), and combinations thereof. The one or more solvents may be selected from the group consisting of: fluoroethylene carbonate (FEC), dimethyl carbonate (DMC), diethyl carbonate (DEC), ethyl methyl carbonate (EMC), and combinations thereof.

In one aspect, two or more of the rollers of the plurality of rollers may be configured to apply the pressure to the pretreated electroactive material. The electroactive material may be a metal film. The metal film may include one or more of aluminum (Al), magnesium (Mg), tin (Sn), indium (In), silicon (Si), and silicon oxide (SiOₓ, where 0≤x≤2). The lithium source may include lithium metal.

In one aspect, the electrolyte may be a first electrolyte and the method may further include incorporating the lithiated electroactive material into an electrochemical cell that cycles lithium-ions. The electrochemical cell may include a second electrolyte having less than or equal to about 5% of cyclic carbonates.

In one aspect, the second electrolyte may include one or more electrolyte additives. The one or more electrolyte additives may be selected from the group consisting of:

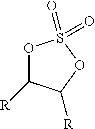

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

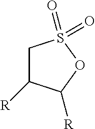

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

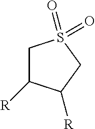

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

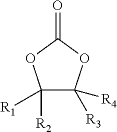

where at least of R₁, R₂, R₃, and R₄ are independently selected from hydrogen (H), fluorine (F), chloride (Cl), bromide (Br), iodide (I), cyanide (CN), nitrogen dioxide (NO₂), alkyl, alkenyl, aryl, aralkyl, heterocyclyl, heteroaryl, heteroaralkyl, and fluoroalkyl and at least one of R₁, R₂, R₃, and R₄ comprises fluorine (F); bis(trimethylsilyl)amine (HMDS); N,N,1,1,1-pentamethylsilanamine; and combinations thereof.

In one aspect, the second electrolyte may include greater than or equal to about 0.1 wt. % to less than or equal to about 5 wt. % of the one or more electrolyte additives.

In one aspect, the one or more electrolyte additives may include one or more of fluoroethylene carbonate (FEC), 4,5-difluoro-1,3-dioxolan-2-one (DFEC), 1,3,2-dioxathiolane-2,2-dioxide (DTD), and bis(trimethylsilyl)amine (HMDS).

In various other aspects, the present disclosure provides a method for preparing an electrochemical cell that cycles lithium ions. The method includes incorporating a lithiated electroactive material as a negative electrode in the electrochemical cell. The lithiated electroactive material may be formed by a process including contacting the electroactive material and a first electrolyte to form a pretreated electroactive material; contacting a lithium source and the pretreated electroactive material; and applying a pressure to the lithium source and the pretreated electroactive material so as to form a lithiated electroactive material. The lithiated electroactive material in the electrochemical cell may be in contact with a second electrolyte.

In one aspect, the first electrolyte may include greater than or equal to about 0.1 M to less than or equal to about 4.0 M of one or more lithium salts and greater than or equal to about 10 wt. % to less than or equal to about 50 wt. % of one or more solvents. The one or more lithium salts may be selected from the group consisting of: lithium hexafluorophosphate (LiPF₆), lithium fluorosulfonylimide (LiN(FSO₂)₂) (LiFSI), lithium perchlorate (LiClO₄), lithium tetrafluoroborate (LiBF₄), and combinations thereof. The one or more solvents may be selected from the group consisting of: fluoroethylene carbonate (FEC), dimethyl carbonate (DMC), diethyl carbonate (DEC), ethyl methyl carbonate (EMC), and combinations thereof.

In one aspect, the second electrolyte may include less than or equal to about 5% of cyclic carbonates.

In one aspect, the second electrolyte may include one or more electrolyte additives. The one or more electrolyte additives may be selected from the group consisting of:

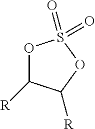

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

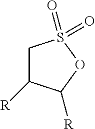

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

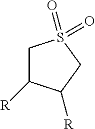

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

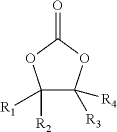

where at least of R₁, R₂, R₃, and R₄ are independently selected from hydrogen (H), fluorine (F), chloride (Cl), bromide (Br), iodide (I), cyanide (CN), nitrogen dioxide (NO₂), alkyl, alkenyl, aryl, aralkyl, heterocyclyl, heteroaryl, heteroaralkyl, and fluoroalkyl and at least one of R₁, R₂, R₃, and R₄ comprises fluorine (F); bis(trimethylsilyl)amine (HMDS); N,N,1,1,1-pentamethylsilanamine; and combinations thereof.

In one aspect, the second electrolyte may include greater than or equal to about 0.1 wt. % to less than or equal to about 5 wt. % of the one or more electrolyte additives.

In one aspect, the method may be a continuous process conducted at least partially on a roller system including a plurality of rollers. Two or more rollers of the plurality of rollers may be configured to conduct the applying pressure to the lithium source and the pretreated electroactive material. The pressure applied may be greater than or equal to about 10 PSI to less than or equal to about 100 PSI.

In one aspect, the plurality of rollers may further includes at least one additional roller that is at least partially disposed within the electrolyte, so that the at least one additional roller is configured to conduct the contacting of the electroactive material and the electrolyte to form the pretreated electroactive material prior to encountering the two or more rollers.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an example electrochemical battery that cycles lithium ions;

FIG. 2 is a schematic of an example roll-to-roll process for lithiating an electroactive material;

FIG. 3 is a schematic of another example of a roll-to-roll process for lithiating an electroactive material;

FIG. 4 is a schematic of an example of a direct pressure process for lithiating an electroactive material;

FIG. 5A is a graphical illustration of the capacity retention per cycle of comparative electrochemical cells;

FIG. 5B is a graphical illustration of the capacity retention per cycle of other comparative electrochemical cells;

FIG. 5C is a graphical illustration of the capacity retention per cycle of further comparative electrochemical cells; and

FIG. 5D is a graphical illustration of the capacity retention per cycle of still other comparative electrochemical cells.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers, and/or sections should not be limited by these terms, unless otherwise indicated. These terms may be only used to distinguish one step, element, component, region, layer, or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electroactive materials for use in electrodes of lithium-ion electrochemical cells and methods of making the same, for example methods for lithiating electroactive materials (e.g., metal anodes), so as to reduce operation inefficiencies resulting from, for example, loss of active lithium ions during the first cell cycle. For example, the method generally includes, for example, contacting an electroactive material and an electrolyte to pretreat the electroactive material and lithiating the pretreated electroactive material by contacting the pretreated electroactive material and a lithium source while applying pressure. The present technology also relates to electrolyte and electrolyte additives for use in electrochemical cells including the lithiated electroactive materials, for example lithiated metal anodes.

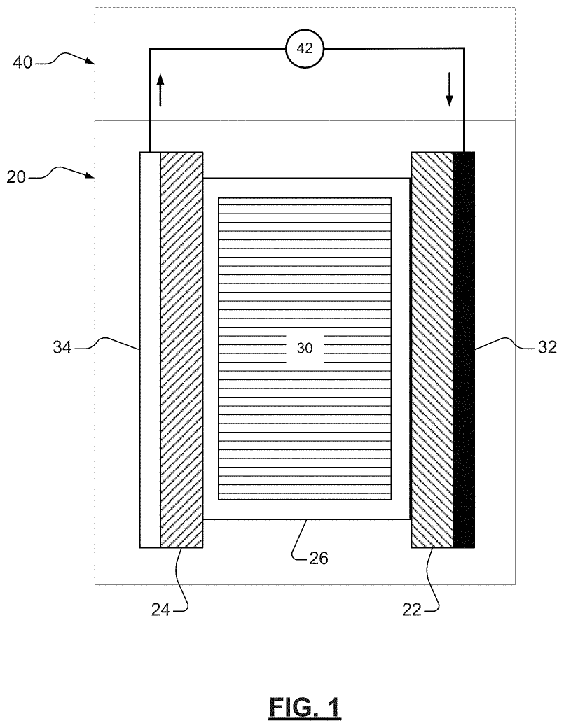

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. For example, an exemplary and schematic illustration of an electrochemical cell (also referred to as the battery) 20 is shown in FIG. 1. Though the illustrated example includes a single cathode 24 and a single anode 22, the skilled artisan will recognize that the current teachings apply to various other configurations, including those having one or more cathodes and one or more anodes, as well as various current collectors with electroactive layers disposed on or adjacent to one or more surfaces thereof.

The battery 20 includes a negative electrode 22, a positive electrode 24, and a separator 26 disposed between the electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte 30. For example, the separator 26 may be defined by a plurality of solid-state electrolyte particles (not shown).

A negative electrode current collector 32 may be positioned at or near the negative electrode 22, and a positive electrode current collector 34 may be positioned at or near the positive electrode 24. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34). The positive electrode current collector 34 may be a metal foil, metal grid or screen, or expanded metal, comprising aluminum or any other appropriate electrically conductive material known to those of skill in the art. The negative electrode current collector 32 may be a metal foil, metal grid or screen, or expanded metal, comprising copper or any other appropriate electrically conductive material known to those of skill in the art.

The battery 20 may generate an electric current during discharge by way of reversible electrochemical reactions that occur when the external circuit 40 is closed (to connect the negative electrode 22 and the positive electrode 24) and the negative electrode 22 has a lower potential than the positive electrode 24. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions, which are also produced at the negative electrode 22, are concurrently transferred through the electrolyte 30 contained in the separator 26 towards the positive electrode 24. The electrons flow through the external circuit 40 and the lithium ions migrate across the separator 26 containing the electrolyte solution 30 to form intercalated lithium at the positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24, so that electrons and lithium ions are produced. The lithium ions flow back towards the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 described above includes a liquid electrolyte and shows representative concepts of battery operation. However, the battery 20 may also be a solid-state battery that includes a solid-state electrolyte that may have a different design, as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30, for example inside their pores, capable of conducting lithium ions between the negative electrode 22 and the positive electrode 24. Any appropriate electrolyte 30, whether in solid, liquid, or gel form, capable of conducting lithium ions between the electrodes 22, 24, may be used in the battery 20. For example, the electrolyte 30 may be a non-aqueous liquid electrolyte solution that includes one or more lithium salts dissolved in an organic solvent or a mixture of organic solvents. Numerous conventional non-aqueous liquid electrolyte solutions may be employed in the battery 20.

Appropriate lithium salts generally have inert anions. A non-limiting list of lithium salts that may be dissolved in an organic solvent or a mixture of organic solvents to form the non-aqueous liquid electrolyte solution include lithium hexafluorophosphate (LiPF₆); lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium perchlorate (LiClO₄), lithium difluorooxalatoborate (LiBF₂(C₂O₄)) (LiODFB), lithium tetraphenylborate (LiB(C₆H₅)₄), lithium bis-(oxalate)borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), lithium fluoroalkylphosphate (LiFAP) (Li₃O₄P), and combinations thereof.

These and other similar lithium salts may be dissolved in a variety of organic solvents, including, but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethyl methyl carbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane (DME), 1-2-diethoxyethane, ethoxymethoxyethane), cyclic ethers (e.g., tetrahydrofuran, 2-methyltetrahydrofuran, 1,3-dioxolane (DOL)), sulfur compounds (e.g., sulfolane), and combinations thereof.

In various aspects, the electrolyte 30 may include less than or equal to about 5 vol. %, less than or equal to about 4 vol. %, and in certain aspects, optionally less than or equal to about 3 vol. %, of cyclic carbonates, including for example fluoroethylene carbonate (FEC). For example the electrolyte 30 may include greater than about 0 vol % to less than or equal to about 5 vol. %, greater than about 0 vol % to less than or equal to about 4 vol. %, and in certain aspects, optionally greater than about 0 vol % to less than or equal to about 3 vol. %, of cyclic carbonates. In various aspects, the electrolyte may have a concentration of the one or more lithium salts greater than or equal to 0.01 M to less than or equal to about 4 M.

In various aspects, the electrolyte 30 may further include one or more electrolyte additives. For example, the electrolyte 30 may include greater than or equal to about 0.1 wt. % to less than or equal to about 5 wt. % of the one or more electrolyte additives. The one or more electrolyte additives may be selected from the group consisting of:

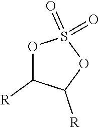

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

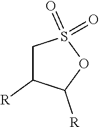

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

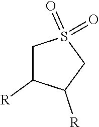

where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃;

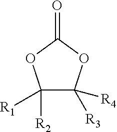

where at least of R₁, R₂, R₃, and R₄ are independently selected from hydrogen (H), fluorine (F), chloride (Cl), bromide (Br), iodide (I), cyanide (CN), nitrogen dioxide (NO₂), alkyl, alkenyl, aryl, aralkyl, heterocyclyl, heteroaryl, heteroaralkyl, and fluoroalkyl and at least one of R₁, R₂, R₃, and R₄ comprises fluorine (F); bis(trimethylsilyl)amine (HMDS), N,N,1,1,1-pentamethylsilanamine; and combinations thereof.

For example, in various aspects, the one or more electrolyte additives may include:

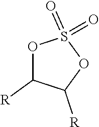

where R is H (e.g. 1,3,2-dioxathiolane-2,2-dioxide (DTD)). In certain variations, the one or more electrolyte additives may include:

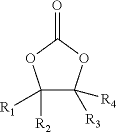

where R₁, R₂, R₃, and R₄ are independently selected from hydrogen (H), fluorine (F), C1-C8 alkyl, and C1-C8 fluoroalkyl and at least one of R₁, R₂, R₃, and R₄ comprises fluorine (F). In certain other variations, the one or more electrolyte additives may include:

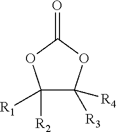

where R₁, R₂, and R₃ are hydrogen (H) and R₄ is fluorine (F) (e.g., fluoroethylene carbonate (FEC)). In other variations, the one or more electrolyte additives may include:

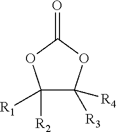

where R₁ and R₂ are hydrogen (H) and R₃ and R₄ is fluorine (F). In further other variations, the one or more electrolyte additives may include:

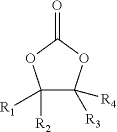

where R₂ and R₃ are hydrogen (H) and R₁ and R₄ is fluorine (F) (e.g., 4,5-difluoro-1,3-dioxolan-2-one (DFEC)). In still other variations, the one or more electrolyte additives may include:

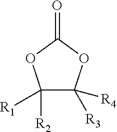

where R₁, R₂, R₃, and R₄ are each fluorine (F).

A solid-state electrolyte may include one or more solid-state electrolyte particles that may comprise one or more polymer-based particles, oxide-based particles, sulfide-based particles, halide-based particles, borate-based particles, nitride-based particles, and hydride-based particles. Such a solid-state electrolyte may be disposed in a plurality of layers so as to define a three-dimensional structure, and in certain aspects, the separator 26. In various aspects, the polymer-based particles may be intermingled with a lithium salt so as to act as a solid solvent.

In various aspects, the oxide-based particles may comprise one or more garnet ceramics, LISICON-type oxides, NASICON-type oxides, and Perovskite-type ceramics. For example, the one or more garnet ceramics may be selected from the group consisting of: Li_{6.5}La₃Zr_{1.75}Te_{0.25}O₁₂, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, and combinations thereof. The one or more LISICON-type oxides may be selected from the group consisting of: Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The one or more NASICON-type oxides may be defined by LiMM′(PO₄)₃, where M and M′ are independently selected from Al, Ge, Ti, Sn, Hf, Zr, and La. For example, in certain variations, the one or more NASICON-type oxides may be selected from the group consisting of: Li₁₊ₓAlₓGe₂₋ₓ(PO₄)₃ (LAGP) (where 0≤x≤2), Li₁₊ₓAlₓTi₂₋ₓ(PO₄)₃ (LATP) (where 0≤x≤2), Li₁₋ₓYₓZr₂₋ₓ(PO₄)₃ (LYZP) (where 0≤X≤2), Li₁₃Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The one or more Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}M_{3/4}Zr_{1/4}O₃, Li₃ₓLa_{(2/3-x)}TiO₃ (where 0<x<0.25), and combinations thereof.

In various aspects, the polymer-based particles may comprise one or more of polymer materials selected from the group consisting of: polyethylene glycol, poly(p-phenylene oxide) (PPO), poly(methyl methacrylate) (PMMA), polyacrylonitrile (PAN), polyvinylidene fluoride (PVDF), poly(vinylidene fluoride-co-hexafluoropropylene (PVDF-HFP), polyvinyl chloride (PVC), and combinations thereof. The sulfide-based particles may include one or more sulfide-based materials selected from the group consisting of: Li₂S—P₂S₅, Li₂S—P₂S₅-MSₓ (where M is Si, Ge, and Sn and 0≤x≤2), Li_{3.4}Si_{0.4}P_{0.6}S₄, Li₁₀GeP₂S_{11.7}O_{0.3}, Li_{9.6}P₃S₁₂, Li₇P₃S₁₁, Li₉P₃S₉O₃, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li(Ge_{0.5}Sn_{0.5})P₂S₁₂, Li(Si_{0.5}Sn_{0.5})P₅S₁₂, Li₁₀GeP₂S₁₂ (LGPS), Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1-X)P₂S_{5-X}Li₂S (where 0.5≤x≤0.7), and combinations thereof. The halide-based particles may include one or more halide-based materials selected from the group consisting of: Li₂CdCl₄, Li₂MgCl₄, Li₂CdI₄, Li₂ZnI₄, Li₃OCl, LiI, Li₅ZnI₄, Li₃OCl₁₋ₓBrₓ (where 0<x<1), and combinations thereof.

In various aspects, the borate-based particles may include one or more borate-based materials selected from the group consisting of: Li₂B₄O₇, Li₂O—(B₂O₃)—(P₂O₅), and combinations thereof. The nitride-based particles may include one or more nitride-based materials selected from the group consisting of: Li₃N, Li₇PN₄, LiSi₂N₃, LiPON, and combinations thereof. The hydride-based particles may include one or more hydride-based materials selected from the group consisting of: Li₃AlH₆, LiBH₄, LiBH₄—LiX (where X is one of Cl, Br, and I), LiNH₂, Li₂NH, LiBH₄—LiNH₂, and combinations thereof. In still further variations, the electrolyte 30 may be a quasi-solid electrolyte comprising a hybrid of the above-detailed non-aqueous liquid electrolyte solution and solid-state electrolyte systems—for example, including one or more ionic liquids and one or more metal oxide particles, such as aluminum oxide (Al₂O₃) and/or silicon dioxide (SiO₂).

In various aspects, such as when the electrolyte 30 is a non-aqueous liquid electrolyte solution, the separator 26 may be a microporous polymeric separator including, for example a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous membranes include CELGARD® 2500 (a monolayer polypropylene separator) and CELGARD® 2320 (a trilayer polypropylene/polyethylene/polypropylene separator) available from Celgard LLC. Various other conventionally available polymers and commercial products for forming the separator 26 are contemplated, as well as the many manufacturing methods that may be employed to produce such a microporous polymer separator 26.

When the separator 26 is a microporous polymeric separator, it may be a single layer or a multi-layer laminate, which may be fabricated from either a dry or wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26.

The separator 26 may also comprise other polymers in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, acrylonitrile-butadiene styrene copolymers (ABS), polystyrene copolymers, polymethylmethacrylate (PMMA), polysiloxane polymers (e.g., polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF-hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), titania (TiO₂), and combinations thereof. The heat-resistant material may be selected from the group consisting of: Nomex, Aramid, and combinations thereof.

In various aspects, the positive electrode 24 comprises a lithium-based positive electroactive material that is capable of undergoing lithium intercalation and deintercalation, alloying and dealloying, or plating and stripping, while functioning as a positive terminal of the capacitor battery 20. In various aspects, the positive electrode 24 may be defined by a plurality of electroactive material particles (not shown). Such positive electroactive material particles may be disposed in one or more layers so as to define the three-dimensional structure of the positive electrode 24. In certain variations, as noted above, the positive electrode 24 may further include the electrolyte 30, for example a plurality of electrolyte particles (not shown).

In various aspects, the positive electrode 24 may be one of a layered-oxide cathode, a spinel cathode, and a polyanion cathode. For example, layered-oxide cathodes (e.g., rock salt layered oxides) comprise one or more lithium-based positive electroactive materials selected from LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where M is one of Mn, Ni, Co, and Al and 0≤x≤1) (for example LiCoO₂ (LCO), LiNiO₂, LiMnO₂, LiNi_{0.5}Mn_{0.5}O₂, NMC111, NMC523, NMC622, NMC721, NMC811, NCA). Spinel cathodes comprise one or more lithium-based positive electroactive materials selected from LiMn₂O₄ and LiNi_{0.5}Mn_{1.5}O₄. Olivine type cathodes comprise one or more lithium-based positive electroactive material such as LiV₂(PO₄)₃, LiFePO₄, LiCoPO₄, and LiMnPO₄. Tavorite type cathodes comprise, for example, LiVPO₄F. Borate type cathodes comprise, for example, one or more of LiFeBO₃, LiCoBO₃, and LiMnBO₃. Silicate type cathodes comprise, for example, Li₂FeSiO₄, Li₂MnSiO₄, and LiMnSiO₄F. In still further variations, the positive electrode 24 may comprise one or more other positive electroactive materials, such as one or more of dilithium (2,5-dilithiooxy)terephthalate and polyimide. In various aspects, the positive electroactive material may be optionally coated (for example by LiNbO₃ and/or Al₂O₃) and/or may be doped (for example by one or more of magnesium (Mg), aluminum (Al), and manganese (Mn)).

The positive electroactive material of the positive electrode 24 may be optionally intermingled with one or more electrically conductive materials that provide an electron conductive path and/or at least one polymeric binder material that improves the structural integrity of the positive electrode 24. For example, the positive electroactive material in the positive electrode 24 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

For example, the positive electrode 24 may include greater than or equal to about 50 wt. % to less than or equal to about 99 wt. %, and in certain aspects, optionally greater than or equal to about 50 wt. % to less than or equal to about 95 wt. %, of the positive electroactive material; greater than or equal to about 0 wt. % to less than or equal to about 30 wt. %, and in certain aspects, optionally greater than or equal to about 2 wt. % to less than or equal to about 5 wt. %, of one or more electrically conductive materials; and greater than or equal to about 0 wt. % to less than or equal to about 20 wt. %, and in certain aspects, optionally greater than or equal to about 2 wt. % to less than or equal to about 5 wt. %, of one or more binders.

In various aspects, the negative electrode 22 comprises a lithium host material that is capable of functioning as a negative terminal of a lithium-ion battery. For example, the negative electrode 22 may comprise a lithium host material (e.g., negative electroactive material) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. For example, in various aspects, the negative electrode 22 may be a metal film or foil. In certain variations, as noted above, the negative electrode 22 may further include the electrolyte 30, for example a plurality of electrolyte particles (not shown).

The negative electrode 22 may include a negative electroactive material that is lithium based comprising, for example, a lithium metal and/or lithium alloy (e.g., lithium silicon alloy, lithium aluminum alloy, lithium indium alloys). In other variations, the negative electrode 22 may include a negative electroactive material that is silicon based comprising silicon, for example, silicon, a silicon alloy, silicon oxide, or combinations thereof that may be further mixed, in certain instances, with graphite. In still other variations, the negative electrode 22 may be a negative electroactive material that is a carbonaceous anode comprising, for example, one or more negative electroactive materials such as graphite, graphene, and/or carbon nanotubes (CNTs). In still further variations, the negative electrode 22 may comprise one or more lithium-accepting negative electroactive materials, such as lithium titanium oxide (Li₄TiSO₁₂), one or more transition metals (such as tin (Sn)), one or more metal oxides (such as vanadium oxide (V₂O₅), tin oxide (SnO), titanium dioxide (TiO₂)), titanium niobium oxide (TiₓNb_{y}O_{z}, where 0≤x≤2, 0≤y≤24, and 0≤z≤64), and one or more metal sulfides (such as ferrous or iron sulfide (FeS)). As further detailed below, in various aspects, the negative electroactive material may be pre-lithiated.

In various aspects, the negative electroactive material in the negative electrode 22 may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

For example, the negative electrode 22 may include greater than or equal to about 50 wt. % to less than or equal to about 99 wt. %, and in certain aspects, optionally greater than or equal to about 50 wt. % to less than or equal to about 95 wt. %, of the negative electroactive material; greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 5 wt. % to less than or equal to about 15 wt. %, of one or more binders.

As further detailed above, during discharge, the negative electrode 22 may contain a comparatively high concentration of intercalated lithium, which is oxidized into lithium ions and electrons. Lithium ions may travel from the negative electrode 22 to the positive electrode 24, for example, through the ionically conductive electrolyte 30 contained within the pores of an interposed porous separator 26. Concurrently, electrons pass through an external circuit 40 from the negative electrode 22 to the positive electrode 24. Such lithium ions may be assimilated into the material of the positive electrode 24 by an electrochemical reduction reaction. The battery may be recharged or regenerated after a partial or full discharge of its available capacity by an external power source, which reverses the electrochemical reactions that transpired during discharge.

In various instances, however, especially in instances of electrochemical cells including silicon, a portion of the intercalated lithium remains with the negative electrode 22 following a first cycle due to, for example, the formation of a solid electrolyte interphase (SEI) layer (not shown) on the negative electrode 22 during the first cycle, as well as, for example, ongoing lithium loss due to continuous solid electrolyte interphase breakage. For example, electrochemical cells including negative electrodes comprising silicon may experience a first cycle capacity loss of about 20%, and in certain aspects, about 40%. Likewise, electrochemical cells including negative electrodes comprising silicon or silicon oxides (SiOₓ) may experience a first cycle capacity loss of about 40%. Such first cycle capacity losses create situations of low energy densities. This permanent loss of lithium ions may result in a decreased specific energy and power in the battery 20 resulting from, for example, added positive electrode mass that does not participate in the reversible operation of the battery.

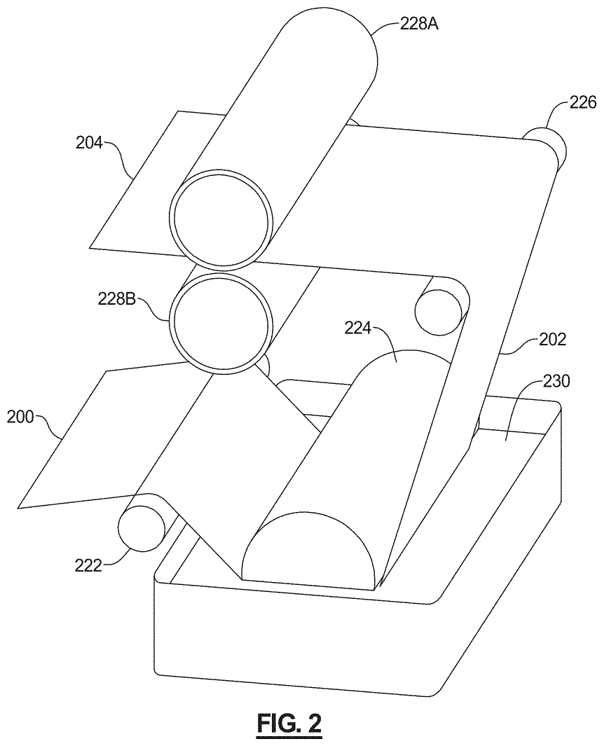

In various aspects, the present disclosure provides a method for lithiating electroactive materials, for example lithiating electroactive materials for use within negative electrode 22 as illustrated in FIG. 1. The method includes, for example, contacting an electroactive material and an electrolyte to pretreat the electroactive material and lithiating the pretreated electroactive material by contacting the pretreated electroactive material and a lithium source while applying pressure. As illustrated in FIG. 2, the method may include using a roll-to-roll process, where lithiation can be performed by moving an electroactive material 200 on a roller system 210 including a plurality of rollers where at least one roller 224 of the plurality of rollers is at least partially disposed within an electrolyte bath 230 so as to pretreat the electroactive material 200 traveling thereacross and two or more rollers 228A, 228B of the plurality of rollers are formed from or coated with a lithium source, for example lithium metal, and configured to apply a pressure to the pretreated electroactive material 202 traveling therebetween. The electroactive material 200 may be a metal film or foil comprising, for example, one or more of aluminum (Al), magnesium (Mg), tin (Sn), indium (In), silicon (Si), and silicon oxide (SiOₓ, where 0≤x≤2).

As illustrated, in various aspects, the electroactive material 200 may move from a first roller 222 to a second roller 224 that is at least partially disposed within an electrolyte bath 230. The diameter of the second roller 224, as well as depth of the electrolyte bath 230 and the rotational speeds of the plurality of rollers may be selected to ensure sufficient exposure to of the electroactive material 200 to the electrolyte bath 230. For example, the second roller 224 may have a diameter greater than or equal to about 0.1 inch to less than or equal to about 100 inches. In certain aspects, the electroactive material 200 may be exposed to the electrolyte bath 230 for a time period greater than or equal to about 10 seconds to less than or equal to about 12 hours.

The electrolyte bath 230 includes one or more lithium salts dissolved in an organic solvent or a mixture of organic solvents. For example, in various aspects, the electrolyte bath 230 includes one or more lithium salts selected from the group consisting of: lithium hexafluorophosphate (LiPF₆), lithium fluorosulfonylimide (LiN(FSO₂)₂) (LiFSI), lithium perchlorate (LiClO₄), lithium tetrafluoroborate (LiBF₄), and combinations thereof and one or more solvents selected from the group consisting of: fluoroethylene carbonate (FEC), dimethyl carbonate (DMC), diethyl carbonate (DEC), ethyl methyl carbonate (EMC), and combinations thereof. For example, the electrolyte bath 230 may have a concentration of the one or more lithium salts greater than or equal to 0.01 M to less than or equal to about 4 M. The electrolyte bath 230 may comprise greater than or equal to about 10 wt. % to less than or equal to about 50 wt. % of the one or more solvents.

The electroactive material 200 is wetted with the electrolyte 230 as it travels across the second roller 224. In certain variations, the electrolyte 230 may cause the formation of an artificial solid electrolyte interphase (SEI) layer on the electroactive material 200. The electroactive material 200 including an artificial solid electrolyte interphase (SEI) layer on one or more surfaces thereof may define a pretreated electroactive material 202.

After sufficient exposure the electrolyte 230, the pretreated electroactive material 202, including, for example, the artificial solid electrolyte interphase (SEI) layer, may move from the second roller 224 to a third roller 226 so as to help to align or fix the pretreated electroactive material 202 with two or more compression rollers 228A, 228B that are configured or aligned so as to apply a pressure to pretreated electroactive material 202. The two or more compression rollers 228A, 228B may be configured to apply a pressure to the pretreated electroactive material 202 that is greater than 0 PSI to less than or equal to about 100 PSI, greater than 10 PSI to less than or equal to about 100 PSI, greater than 1 PSI to less than or equal to about 15 PSI, and in certain aspects, optionally greater than or equal to about 10 PSI to less than or equal to about 15 PSI.

Like the second roller 224, the two or more compression rollers 228A, 228B may have a diameter so as to ensure that the two or more compression rollers 228A, 228B apply a pressure to the pretreated electroactive material 202 for a sufficient period of time. For example, the two or more compression rollers 228A, 228B may each have a diameter greater than or equal to about 0.1 inch to less than or equal to about 100 inches. The two or more compression rollers 228A, 228B may be configured to apply the pressure for greater than or equal to about 2 minutes to less than or equal to about 12 hours. The two or more compression rollers 228A, 228B formed from or coated with a lithium source, such as lithium metal. The lithium source may react with the electroactive material and/or artificial solid electrolyte interphase (SEI) layer of the pretreated electroactive material 202 so as form a lithiate electroactive material 204.

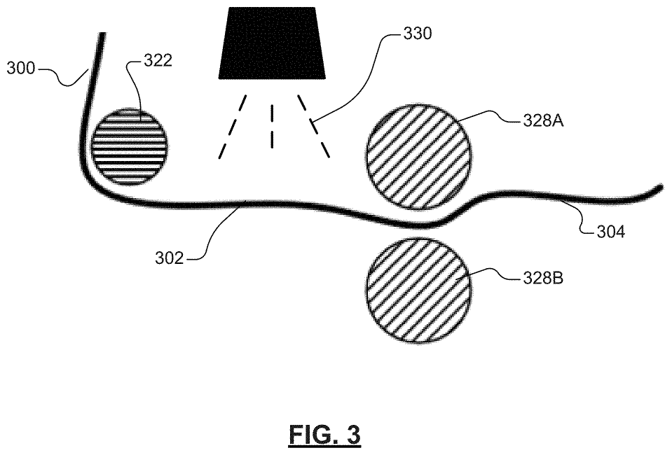

In various aspects, the present disclosure provides another method for lithiating electroactive materials, for example lithiating electroactive materials for use within negative electrode 22 as illustrated in FIG. 1. The method includes, for example, contacting an electroactive material and an electrolyte to pretreat the electroactive material and lithiating the pretreated electroactive material by contacting the pretreated electroactive material and a lithium source while applying pressure. As illustrated in FIG. 3, the method may include moving an electroactive material 300 on a roller system 310 including a plurality of rollers. The electroactive material 300 may be a metal film or foil comprising, for example, one or more of aluminum (Al), magnesium (Mg), tin (Sn), indium (In), silicon (Si), and silicon oxide (SiOₓ, where 0≤x≤2).

The method may include disposing an electrolyte 330 onto one or more surfaces of the electroactive material 300 as the electroactive material 300 travels through the roller system 310. For example, as illustrated, the method may include disposing an electrolyte 330 onto a first surface of the electroactive material 300. The electrolyte 330 may be disposed onto the first surface of the electroactive material 300 moves from a first roller 322 towards two or more compression rollers 328A, 328B. The electrolyte 330 may be disposed onto the first surface of the electroactive material 300 using a controlled spraying system. The electrolyte 330 may be same as the electrolyte bath 230 discussed in reference to FIG. 2.

Like the two or more compression rollers 228A, 228B illustrated in FIG. 2, the two or more compression rollers 328A, 328B may be configured or aligned so as to apply a pressure to pretreated electroactive material 302. For example, the two or more compression rollers 328A, 328B may be configured to apply a pressure to the pretreated electroactive material 202 that is greater than 0 PSI to less than or equal to about 100 PSI, greater than 10 PSI to less than or equal to about 100 PSI, greater than 1 PSI to less than or equal to about 15 PSI, and in certain aspects, optionally greater than or equal to about 10 PSI to less than or equal to about 15 PSI. The pressure may be applied for a time period greater than or equal to about 2 minutes to less than or equal to about 12 hours. The two or more compression rollers 328A, 328B, like the two or more compression rollers 228A, 228B illustrated in FIG. 2, may formed from or coated with a lithium source, such as lithium metal. The lithium source may react with the electroactive material and/or artificial solid electrolyte interphase (SEI) layer of the pretreated electroactive material 302 so as form a lithiate electroactive material 304.

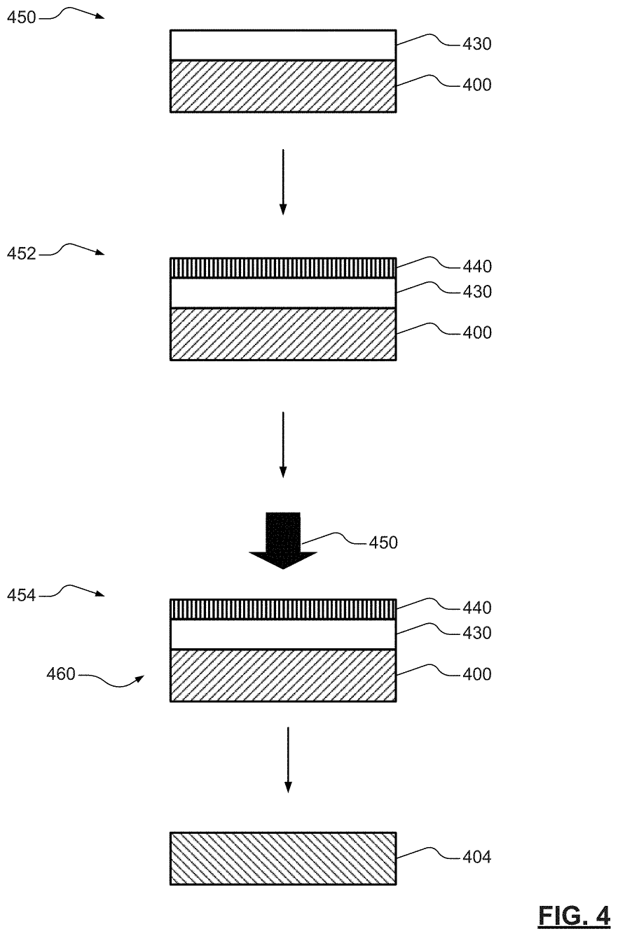

In various aspects, the present disclosure provides yet another method for lithiating electroactive materials, for example lithiating electroactive materials for use within negative electrode 22 as illustrated in FIG. 1. The method includes, for example, contacting an electroactive material and an electrolyte to pretreat the electroactive material and lithiating the pretreated electroactive material by contacting the pretreated electroactive material and a lithium source while applying pressure. As illustrated in FIG. 4, the method may include, for example at 450, disposing an electrolyte 430 onto one or more surfaces of an electroactive material 400, for example disposing about 20 μL per 1 cm² of the one or more surfaces of the electroactive material 400.

The electroactive material 400 may be a metal film or foil comprising, for example, one or more of aluminum (Al), magnesium (Mg), tin (Sn), indium (In), silicon (Si), and silicon oxide (SiOₓ, where 0≤x≤2). Like electrolyte bath 230 discussed in reference to FIG. 2, electrolyte 430 may include one or more lithium salts selected from the group consisting of: lithium hexafluorophosphate (LiPF₆), lithium fluorosulfonylimide (LiN(FSO₂)₂) (LiFSI), lithium perchlorate (LiClO₄), lithium tetrafluoroborate (LiBF₄), and combinations thereof and one or more solvents selected from the group consisting of: fluoroethylene carbonate (FEC), dimethyl carbonate (DMC), diethyl carbonate (DEC), ethyl methyl carbonate (EMC), and combinations thereof. For example, the electrolyte 330 may have a concentration of the one or more lithium salts greater than or equal to 0.01 M to less than or equal to about 4 M.

With renewed reference to FIG. 4, the method may further include, for example at 452, disposing on or adjacent an exposed surface of the disposed electrolyte 430 a lithium source 440, for example a lithium metal film. At 454, a pressure, for example as illustrated by arrow 450, may be applied to the assembly or stack 460, including the lithium source 440, the electrolyte 430, and the electroactive material 400, so as to form a lithiated electroactive material 404.

### EXAMPLES

Embodiments and features of the present technology are further illustrated through the following non-limiting examples:

### Example I—Lithiation Method

An example lithiated silicon anode is prepared in accordance with various aspects of the present disclosure. For example, lithiation of the silicon anode may be performed by moving a silicon-containing film (10 mAh/cm²) having a thickness of about 40 μm on a roller system including a plurality of rollers, where at least one roller of the plurality of rollers is partially disposed within an electrolyte bath and two or more subsequent rollers of the plurality of rollers are formed from or coated with a lithium source and configured to apply a pressure to the pretreated silicon-containing film traveling therebetween. The two or more subsequent rollers may apply a pressure of about 10 PSI for a period of about 2 minutes. The electrolyte bath may include 1.2 M lithium hexafluorophosphate (LiPF₆) in fluoroethylene carbonate (FEC) and ethyl methyl carbonate (EMC) (1:4 vol. ratio). The lithiated silicon anode may be incorporated into a lithium-ion battery 510 including a cathode comprising NMC 622 (4.25 mAh/cm²) and an electrolyte comprising a 1 M concentration of lithium hexafluorophosphate (LiPF₆) in fluoroethylene carbonate (FEC) and ethyl methyl carbonate (EMC) (1:4 vol. ratio).

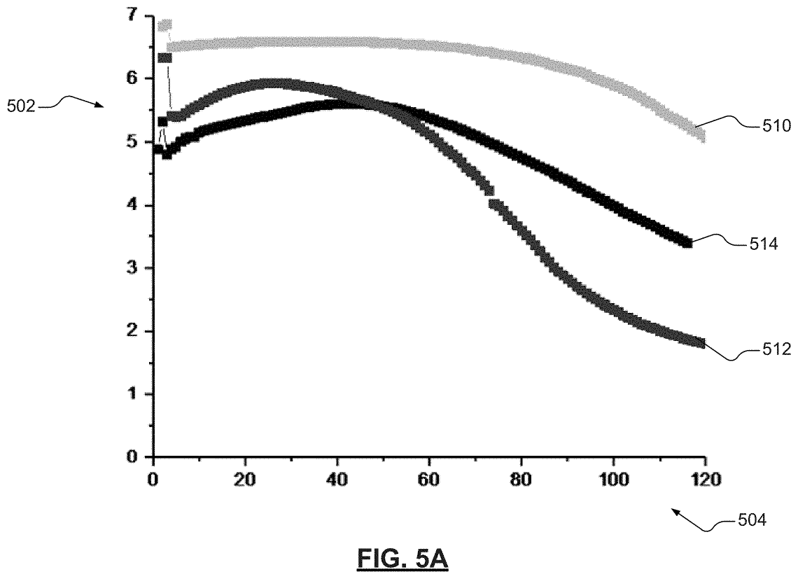

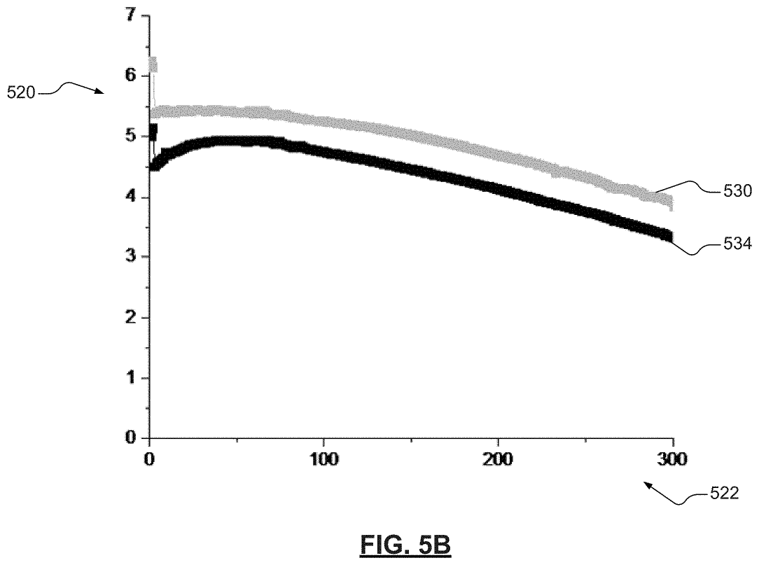

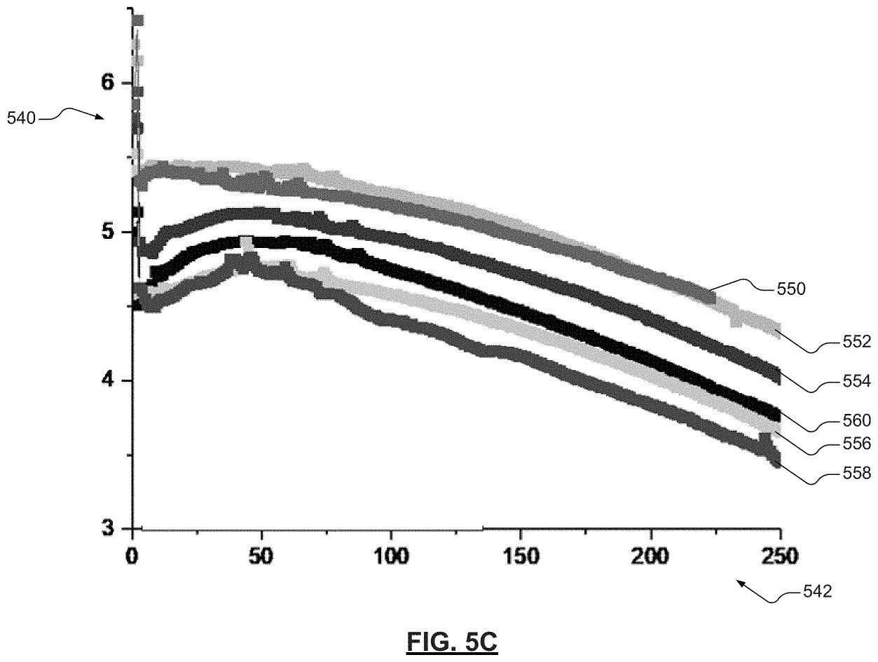

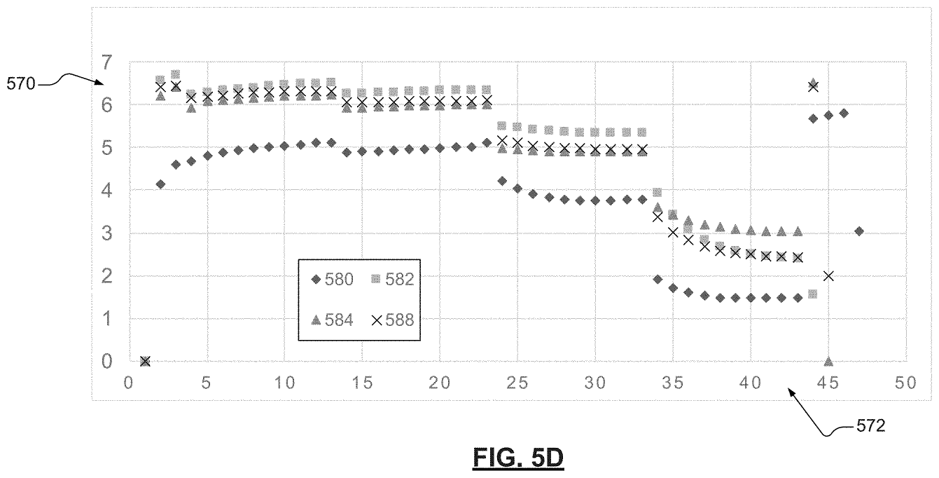

As illustrated in FIG. 5A, lithium-ion battery 510 including the example lithiate silicon anode prepared in accordance with various aspects of the present disclosure may be compared with a first comparable lithium-ion battery 512 having a similar silicon anode that is lithiated using conventional electrochemical methods, including, for example, by directly pressing a lithium metal foil onto the electrode, directly mixing a stabilized lithium metal powder (“SLMP”) with the electrode material, and/or using conventional electrochemical methods; and a second comparable lithium-ion battery 514 also having a similar silicon anode that is not lithiated. The y-axis 502 in FIG. 5A represents capacity (mAh/g), while cycle number is shown on the x-axis 504. As illustrated, the battery incorporating the example lithiated silicon anode 510 has superior long-term performance and stability when compared to batteries 512 and 514, for example a higher first Coulombic efficiency and capacity delivery after prelithiation, as well as improved capacity retention and specific capacity. For example, the first Coulombic efficiency of the example lithiated silicon anode 510 may increase from about 70% to about 80% when compared to batteries 512 and 514; and the discharge capacity of the example lithiated silicon anode 510 may increase from about 150 mAh/g to about 165 mAh/g when compared to batteries 512 and 514.

### Example II—Thickness

Another example lithiated silicon anode is prepared in accordance with various aspects of the present disclosure. For example, lithiation of the silicon anode may be performed by moving a silicon-containing film (15 mAh/cm²) having a thickness of about 60 μm on a roller system including a plurality of rollers, where at least one roller of the plurality of rollers is partially disposed within an electrolyte bath and two or more subsequent rollers of the plurality of rollers are formed from or coated with a lithium source and configured to apply a pressure to the pretreated silicon-containing film traveling therebetween. The two or more subsequent rollers may apply a pressure of about 10 PSI for a period of about 2 minutes. The electrolyte bath may include 1.2 M lithium hexafluorophosphate (LiPF₆) in ethylene carbonate (EC) and ethyl methyl carbonate (EMC) (1:4 vol. ratio). The lithiated silicon anode may be incorporated into a lithium-ion battery 530 including a cathode comprising NMC 622 (4.25 mAh/cm²) and an electrolyte comprising a 1 M concentration of lithium hexafluorophosphate (LiPF₆) in fluoroethylene carbonate (FEC) and ethyl methyl carbonate (EMC) (1:4 vol. ratio).

As illustrated in FIG. 5B, lithium-ion battery 530 including the example lithiate silicon anode prepared in accordance with various aspects of the present disclosure may be compared with a comparable lithium-ion battery 534 also having a similar silicon anode, but not lithiated (e.g., pristine silicon electrode). The y-axis 520 in FIG. 5B represents capacity (mAh), while cycle number is shown on the x-axis 522. As illustrated, the battery incorporating the example lithiated silicon anode 530 has superior long-term performance and stability when compared to battery 534. For example, the example lithiated silicon anode 530 may have an improve capacity delivery of about 10%.

### Example III—Lead Time

FIG. 5C provides a graphical illustrate of the capacity retention per cycle of various comparative electrochemical cells including lithiated silicon anodes (15 mAh/cm²) prepared using various electrolyte systems and lead times in accordance with different aspects of the present disclosure. In each instance, however, the respective lithiated silicon anode may be incorporated into a respective battery including a cathode comprising NMC 622 (4.25 mAh/cm²) and an electrolyte comprising a 1.2 M concentration of lithium hexafluorophosphate (LiPF₆) in fluoroethylene carbonate (FEC) and ethyl methyl carbonate (EMC) (1:4 vol. ratio). Comparable electrochemical cell 560 is a baseline cell comprising a silicon anode that is not lithiated.

Comparable electrochemical cell 550 includes a lithiated silicon anode prepared using an electrolyte bath comprising about a 0.6 M concentration of lithium hexafluorophosphate (LiPF₆) dissolved in a solvent mixture comprising fluoroethylene carbonate (FEC) and ethyl methyl carbonate (EMC) (1:4 vol. ratio). The silicon-containing film may be contacted with the electrolyte for a period greater than or equal to about 30 minutes. A pressure of about 10 PSI may be applied for a period of about 30 minutes.

Comparable electrochemical cell 552 includes a lithiated silicon anode prepared using an electrolyte bath comprising about a 1.2 M concentration of lithium hexafluorophosphate (LiPF₆) dissolved in a solvent mixture comprising fluoroethylene carbonate (FEC) and ethyl methyl carbonate (EMC) (1:4 vol. ratio). The silicon-containing film may be contacted with the electrolyte for a period greater than or equal to about 2 minutes. A pressure of about 10 PSI may be applied for a period of about 2 minutes.

Comparable electrochemical cell 554 includes a lithiated silicon anode prepared using an electrolyte bath comprising about a 0.6 M concentration of lithium hexafluorophosphate (LiPF₆) dissolved in a solvent mixture comprising fluoroethylene carbonate (FEC) and ethyl methyl carbonate (EMC) (1:4 vol. ratio). The silicon-containing film may be contacted with the electrolyte for a period greater than or equal to about 2 minutes. A pressure of about 10 PSI may be applied for a period of about 2 minutes.

Comparable electrochemical cell 556 includes a lithiated silicon anode prepared using an electrolyte bath comprising about a 0.6 M concentration of lithium hexafluorophosphate (LiPF₆) dissolved in a solvent mixture comprising ethyl methyl carbonate (EMC). The silicon-containing film may be contacted with the electrolyte for a period greater than or equal to about 12 hours. A pressure of about 10 PSI may be applied for a period of about 12 hours.

Comparable electrochemical cell 558 includes a lithiated silicon anode prepared using an electrolyte bath including a solvent mixture comprising fluoroethylene carbonate (FEC). The silicon-containing film may be contacted with the electrolyte for a period greater than or equal to about 12 hours. A pressure of about 10 PSI may be applied for a period of about 12 hours.

The y-axis 540 in FIG. 5C represents capacity (mAh), while cycle number is shown on the x-axis 542. As illustrated, electrolytes including, in particular, fluoroethylene carbonate (FEC) and lithium hexafluorophosphate (LiPF₆) initiate lithiation, for example pre-lithiation, when the silicon-containing film is contacted with the electrolyte.

### Example IV—Full Cell Electrolyte Systems

FIG. 5D provides a graphical illustrate of the capacity retention per cycle of various comparative electrochemical cells including lithiated silicon anodes (15 mAh/cm²) and different electrolyte systems. The comparative electrochemical cells may each include a cathode comprising NMC 622 (4.25 mAh/cm²). Comparable electrochemical cell 580 is a baseline cell comprising a silicon anode that is not lithiated and an electrolyte having about 1.2 M concentration of lithium hexafluorophosphate (LiPF₆) dissolved in a solvent mixture comprising ethyl methyl carbonate (EMC) and about 5 vol. % fluoroethylene carbonate (FEC). Comparable electrochemical cell 582 includes a lithiated silicon anode prepared in accordance with various aspect of the present disclosure and an electrolyte dissolved in a solvent mixture comprising ethyl methyl carbonate (EMC) and 5 vol. % fluoroethylene carbonate (FEC). Comparable electrochemical cell 582 includes a lithiated silicon anode prepared in accordance with various aspect of the present disclosure and an electrolyte dissolved in a solvent mixture comprising ethyl methyl carbonate (EMC) and 5 vol. % fluoroethylene carbonate (FEC). Comparable electrochemical cell 584 includes a lithiated silicon anode prepared in accordance with various aspect of the present disclosure and an electrolyte dissolved in a solvent mixture comprising ethyl methyl carbonate (EMC), 2 vol. % fluoroethylene carbonate (FEC), and 2 vol. % 4,5-difluoro-1,3-dioxolan-2-one (DFEC). Comparable electrochemical cell 588 includes a lithiated silicon anode prepared in accordance with various aspect of the present disclosure and an electrolyte dissolved in a solvent mixture comprising ethyl methyl carbonate (EMC), 2 vol. % fluoroethylene carbonate (FEC), and 1 vol. % 1,3,2-dioxathiolane-2,2-dioxide (DTD).

The y-axis 570 in FIG. 5D represents capacity (mAh), while cycle number is shown on the x-axis 572. As illustrated, the lithiated electrodes has improved rate performance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for lithiating an electroactive material, the method comprising:
contacting an electroactive material and an electrolyte to form a pretreated electroactive material;
contacting a lithium source and the pretreated electroactive material; and
applying pressure to the lithium source and the pretreated electroactive material so as to form a lithiated electroactive material,
wherein the method is a continuous process conducted at least partially on a roller system including a plurality of rollers, wherein two or more rollers of the plurality of rollers are configured to conduct the applying pressure to the lithium source and the pretreated electroactive material and the two or more rollers of the plurality of rollers are either surrounded by the lithium source or formed from the lithium source.

2. The method of claim 1, wherein the contacting of the lithium source and the pretreated electroactive material and the applying of pressure to the lithium source and the pretreated electroactive material occurs concurrently.

3. (canceled)

4. The method of claim 1, wherein the plurality of rollers further includes at least one additional roller that is at least partially disposed within the electrolyte, so that the at least one additional roller is configured to conduct the contacting of the electroactive material and the electrolyte to form the pretreated electroactive material prior to encountering the two or more rollers.

5. The method of claim 1, wherein the contacting of the electroactive material and the electrolyte further includes spraying the electrolyte onto one or more surfaces of the electroactive material to form the pretreated electroactive material.

6. (canceled)

7. The method of claim 1, wherein the applied pressure is greater than or equal to about 10 PSI to less than or equal to about 100 PSI.

8. The method of claim 1, wherein the electrolyte includes greater than or equal to about 0.1 M to less than or equal to about 4.0 M of one or more lithium salts selected from the group consisting of: lithium hexafluorophosphate (LiPF₆), lithium fluorosulfonylimide (LiN(FSO₂)₂) (LiFSI), lithium perchlorate (LiClO₄), lithium tetrafluoroborate (LiBF₄), and combinations thereof, and
greater than or equal to about 10 wt. % to less than or equal to about 50 wt. % of one or more solvents selected from the group consisting of: fluoroethylene carbonate (FEC), dimethyl carbonate (DMC), diethyl carbonate (DEC), ethyl methyl carbonate (EMC), and combinations thereof.

9. The method of claim 1,
wherein the electroactive material is a metal film comprising one or more of aluminum (Al), magnesium (Mg), tin (Sn), indium (In), silicon (Si), and silicon oxide (SiOₓ, where 0≤x≤2), and the lithium source comprises lithium metal.

10. The method of claim 1, wherein the electrolyte is a first electrolyte and the method further includes incorporating the lithiated electroactive material into an electrochemical cell that cycles lithium-ions, wherein the electrochemical cell includes a second electrolyte having less than or equal to about 5% of cyclic carbonates.

11. The method of claim 10, wherein the second electrolyte includes one or more electrolyte additives selected from the group consisting of: 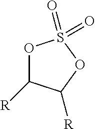
where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃; 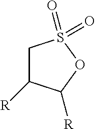
where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃; 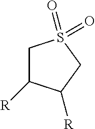
where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃; 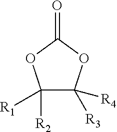
where at least of R₁, R₂, R₃, and R₄ are independently selected from hydrogen (H), fluorine (F), chloride (Cl), bromide (Br), iodide (I), cyanide (CN), nitrogen dioxide (NO₂), alkyl, alkenyl, aryl, aralkyl, heterocyclyl, heteroaryl, heteroaralkyl, and fluoroalkyl and at least one of R₁, R₂, R₃, and R₄ comprises fluorine (F); bis(trimethylsilyl)amine (HMDS); N,N,1,1,1-pentamethylsilanamine; and combinations thereof.

12. The method of claim 11, wherein the second electrolyte includes greater than or equal to about 0.1 wt. % to less than or equal to about 5 wt. % of the one or more electrolyte additives.

13. The method of claim 11, where the one or more electrolyte additives includes one or more of fluoroethylene carbonate (FEC), 4,5-difluoro-1,3-dioxolan-2-one (DFEC), 1,3,2-dioxathiolane-2,2-dioxide (DTD), and bis(trimethylsilyl)amine (HMDS).

14. A method for preparing an electrochemical cell that cycles lithium ions, wherein the method comprises:
incorporating a lithiated electroactive material as a negative electrode in the electrochemical cell, wherein the lithiated electroactive material is formed by a process comprising:
contacting the electroactive material and a first electrolyte to form a pretreated electroactive material;
contacting a lithium source and the pretreated electroactive material; and
applying a pressure to the lithium source and the pretreated electroactive material so as to form a lithiated electroactive material; and
wherein the lithiated electroactive material in the electrochemical cell is in contact with a second electrolyte,
wherein the method is a continuous process conducted at least partially on a roller system including a plurality of rollers,
wherein two or more rollers of the plurality of rollers are configured to conduct the applying pressure to the lithium source and the pretreated electroactive material, and
wherein the two or more rollers of the plurality of rollers are either surrounded by the lithium source or formed from the lithium source.

15. The method of claim 14, wherein the first electrolyte includes greater than or equal to about 0.1 M to less than or equal to about 4.0 M of one or more lithium salts selected from the group consisting of: lithium hexafluorophosphate (LiPF₆), lithium fluorosulfonylimide (LiN(FSO₂)₂) (LiFSI), lithium perchlorate (LiClO₄), lithium tetrafluoroborate (LiBF₄), and combinations thereof, and
greater than or equal to about 10 wt. % to less than or equal to about 50 wt. % of one or more solvents selected from the group consisting of: fluoroethylene carbonate (FEC), dimethyl carbonate (DMC), diethyl carbonate (DEC), ethyl methyl carbonate (EMC), and combinations thereof.

16. The method of claim 14, wherein the second electrolyte includes less than or equal to about 5% of cyclic carbonates.

17. The method of claim 14, wherein the second electrolyte includes one or more electrolyte additives selected from the group consisting of: 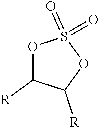
where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃; 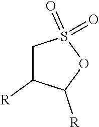
where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃; 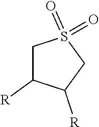
where R is one of H, CH₃, CH₂CH₃, CH₂CH₂CH₂CH₃, CH(CH₃)₂, CH₂CH₂(CH₃)₂, CH₂OCH₃, C₆H₅, CH₂OC₆H₅, CH₂OCH₂CH₃, CH₂OCH(CH₃)₂, C(CH₃)HOCH₃, CH₂CH₂OCH₃, and CH₂CH₂OCH₂CH₃; 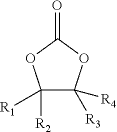
where at least of R₁, R₂, R₃, and R₄ are independently selected from hydrogen (H), fluorine (F), chloride (Cl), bromide (Br), iodide (I), cyanide (CN), nitrogen dioxide (NO₂), alkyl, alkenyl, aryl, aralkyl, heterocyclyl, heteroaryl, heteroaralkyl, and fluoroalkyl and at least one of R₁, R₂, R₃, and R₄ comprises fluorine (F); bis(trimethylsilyl)amine (HMDS); N,N,1,1,1-pentamethylsilanamine; and combinations thereof.

18. The method of claim 17, wherein the second electrolyte includes greater than or equal to about 0.1 wt. % to less than or equal to about 5 wt. % of the one or more electrolyte additives.

19. The method of claim 14, wherein the pressure is greater than or equal to about 10 PSI to less than or equal to about 100 PSI.

20. The method of claim 14, wherein the plurality of rollers further includes at least one additional roller that is at least partially disposed within the electrolyte, so that the at least one additional roller is configured to conduct the contacting of the electroactive material and the electrolyte to form the pretreated electroactive material prior to encountering the two or more rollers.
